(19) United States
(12) Patent Application Publication
(10) Pub. No.: US 2004/0069090 A1
(43) Pub. Date: Apr. 15, 2004

(54) Bicycle control device

(76) Inventor: Yoshihide Iteya, Osaka (JP)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 09/785,026

(22) Filed: Feb. 15, 2001

(51) Int. Cl. B62K 23/00

(52) U.S. Cl. 74/551.8; 74/502.2

(57) ABSTRACT

A bicycle control device having a switch mounting recess therein is disclosed. The bicycle control device could be a shifter, a brake control mechanism or an integrated shifting and brake control device. A control switch of a cycle computer is mountable in the switch mounting recess. The control switch is connected to a cycle computer, located remote from the control switch, by a connecting cable. The control switch can be attached in the switch mounting recess by various means, including, adhesively connecting the control switch to the switch mounting recess. In one embodiment of the invention, the control switch is press fitted into the switch mounting recess. In another embodiment, an elastic portion of the control switch is press fitted into a hole in the switch mounting recess. The control switch can also be securely retained in the switch mounting recess by a retention ring attached to the control device.

### FIELD OF THE INVENTION

The present invention relates generally to bicycle control devices, and more particularly to an electric switch used to operate a bicycle computer, wherein the electrical switch is mounted in a recess defined in the bicycle control device.

### BACKGROUND OF THE INVENTION

Modern bicycles allow the rider to control the gears, the brakes and other features of the bicycle to optimize the rider's experience. Much of the control functions are computerized so that a rider can control the particular function by simply pressing a switch. The switch is usually provided on a computerized control panel of a bicycle. A typical computerized control panel includes a base member mounted to the bicycle handlebar and numerous switches on the control panel, each switch corresponding to a particular function that is controllable by the rider.

During a ride, it is important that the rider be able to conveniently access the control switch associated with a particular function. Moreover, to retain control of the bicycle, it is desirable to provide a switch wherein the switch can be activated by the rider while allowing the rider to, simultaneously, retain a grip on the bicycle handlebar. However, while it is desirable to provide the switch close to the grip, it is not necessarily convenient to have the computerized control panel positioned near the grip for several reasons. First, it is visually more desirable to have the control panel centered in front of the bicycle rider during a ride. Second, a computerized bicycle may already have numerous devices, such as the brake control device and shifter, already attached to the handlebar near the grip. Accordingly, there may be little room for an additional computerized control panel.

Accordingly, it is desirable to provide a control switch that is close to the grip of the handlebar so as to be easily accessible to a bicycle rider during a ride without requiring the rider to remove his or her grip from the handlebar in order to access the control switch.

It is also desirable to provide a control switch that is remote from the cycle computer such that the computer can be installed in a location that is easily viewable by the bicycle rider.

Furthermore, it is desirable to provide a simple and inexpensive method of installing the control switch.

### SUMMARY OF THE PREFERRED EMBODIMENTS

A bicycle control device having a switch mounting recess therein is disclosed. The bicycle control device could be a shifter, a brake control mechanism or an integrated shifting and brake control device. A control switch of a cycle computer is mountable in the switch mounting recess. The control switch is connected to a cycle computer, located remote from the control switch, by a connecting cable. The control switch can be attached in the switch mounting recess by various means, including, adhesively connecting the control switch to the switch mounting recess. In one embodiment of the invention, the control switch is press fitted into the switch mounting recess. In another embodiment, an elastic portion of the control switch is press fitted into a hole in the switch mounting recess. The control switch can also be securely retained in the switch mounting recess by a retention ring attached to the control device.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:

FIG. 1a is a front plan view of a preferred embodiment of the handlebar assembly of the present invention;

FIG. 1b is front plan view of another embodiment of the handlebar assembly of the present invention;

FIG. 2 is a perspective view of a preferred embodiment of the control device of the present invention;

FIG. 3 is a side cross-sectional view of a preferred embodiment of the control switch of the present invention installed in a recess in the control device;

FIG. 4 is a side cross-sectional view of a preferred embodiment of the control switch of the present invention installed in a recess in the control device;

FIG. 5 is a side cross-sectional view of a preferred embodiment of the control switch of the present invention installed in a recess in the control device;

FIG. 6 is a side cross-sectional view of a preferred embodiment of the control switch of the present invention installed in a recess in the control device; and

FIG. 7 is a side cross-sectional view of a preferred embodiment of the control switch of the present invention installed in a recess in the control device.

Like numerals refer to like parts throughout the several views of the drawings.

### DETAILED DESCRIPTION OF THE PREFERRED EMBODIMENTS

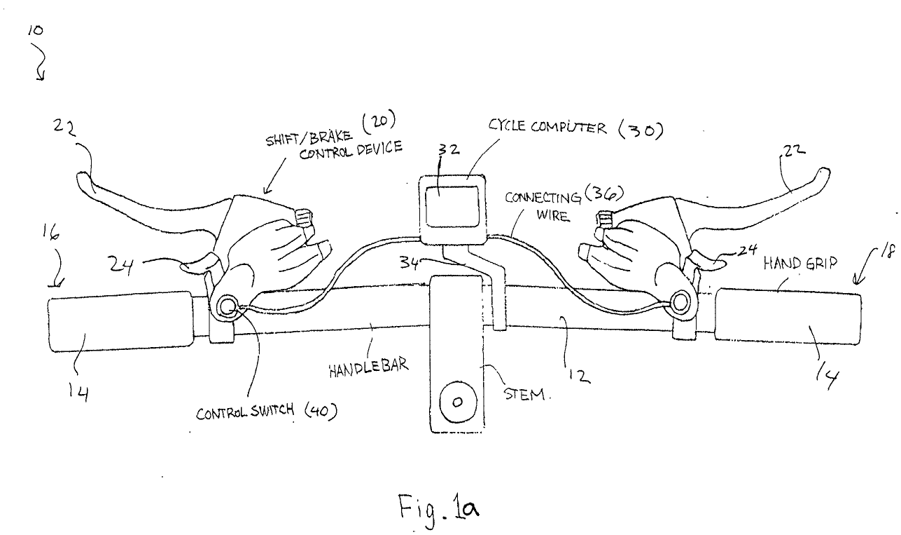

An exemplary embodiment of a handlebar assembly according to the principles of the present invention is illustrated in FIGS. 1a and 1b and identified by reference numeral 10. The handlebar assembly 10 includes a handlebar 12 and a pair of hand grips 14 attached at the opposite ends 16, 18 of the handlebar 12. A control device 20 is preferably attachable to the handlebar at a location proximal to the hand grip 14. A control device is defined herein as a mechanism for controlling a bicycle function, such as a shifter or a brake control apparatus. The control device also includes devices that combine two or more functional controls such as a combined brake and shifting device. In the embodiment shown in FIGS. 1a and 1b, the control device 20 is a combined brake and shifting device. However, it is envisioned that the invention encompasses any type of control device and is not limited to the control device listed and shown herein.

As shown in FIGS. 1a and 1b, in one embodiment of the present invention, the control device 20 includes a brake lever 22, a first shift lever 23 (not shown) and a second shift lever 24. The brake lever 22 controls the braking mechanism of the bicycle when activated, in a manner known in the art. The shift levers 23, 24 control the shifting mechanism of the bicycle when activated, in a manner known in the art. The brake lever 22 and shift levers 23, 24 are preferably positioned on the handlebar 12 at a location proximal the hand grip 14 such that the rider can maintain a hand on the grip 14 while using an index finger to operate the brake lever 22 or shift lever 24 or using a thumb to operate the shift lever 23.

The handlebar assembly 10 preferably includes a cycle computer 30 attached to the handlebar 12. In a preferred embodiment of the invention, the cycle computer includes a computer screen 32 positioned substantially above the center of the handlebar 12. In the embodiment shown in FIGS. 1a and 1b, the cycle computer 30 includes a computer bracket 34. The computer bracket 34 is attachable to the handlebar 12 and when installed maintains the cycle computer 30 in a stable, rigid position.

The cycle computer 30 is preferably operable using a control switch 40. In a preferred embodiment of the invention, the control switch 40 is positioned at a location remote from the cycle computer 30. Specifically, as shown in FIGS. 1a and 1b, the control switch 40 is provided on the control device 20 in a position that is conveniently accessible to the rider. In the embodiment shown in FIG. 1a, the rider can maintain a grip on the hand grip 14 while using an index finger to operate a brake lever 22 or a shift lever 24, and using a thumb to operate a shift lever 23 or control switch 40. In another embodiment of the invention, as shown in FIG. 1b, the control switch 40 is located on the control device 20 at a location that is conveniently accessible by the rider's index finger.

By providing the control switch 40 at a location remote from the cycle computer 30, the necessity of installing the computer 30 proximal to or integral with the control device 20 is eliminated. In this regard, the computer 30, and the computer screen 32, can be installed at a location that is more convenient for viewing by the rider while the control switch 40 can be installed at a location that is near the rider's hand. The control switch 40 is electrically connected to the computer 30 by the connecting cable 36. The connecting cable has one end attached to the control switch and the other end attached to the computer, such that by activation of the control switch 40, the rider activates a computer operation by the cycle computer 30. In another embodiment of the invention, the control switch 40 and the cycle computer 30 are in electrical communication via a remote wireless connection, known in the art.

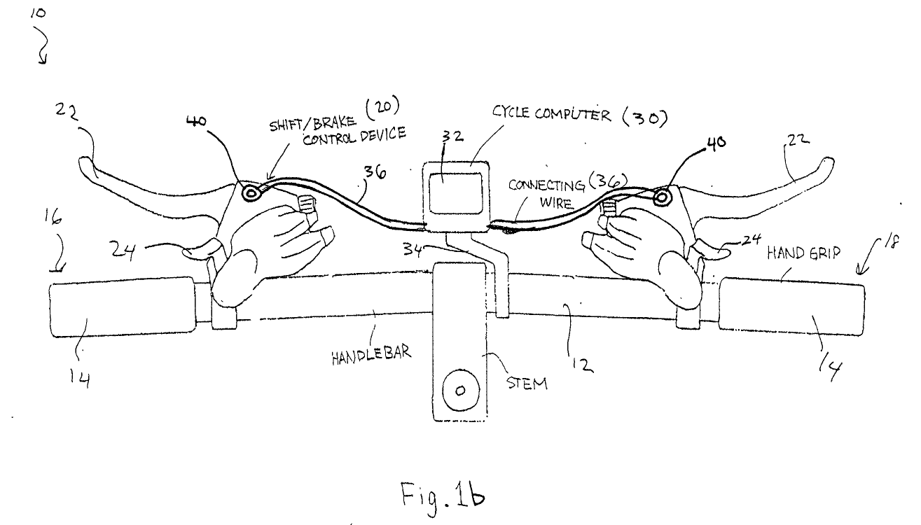

As shown in FIG. 2, the control device 20 of the present invention is provided with a switch mounting recess 42. In a preferred embodiment of the invention, the switch mounting recess 42 is a bottomed hole for inserting and securing the control switch 40. The switch mounting recess 42 has the same shape as the control switch 40 and is configured to closely fit the control switch 40. In a preferred embodiment of the invention, the switch mounting recess 42 is dimensioned such that when the control switch 40 is installed, the control switch 40 is flush with the surface of the control device 44, shown in FIG. 2.

The control device 20 preferably includes a cable mounting recess 50 therein dimensioned to receive a portion of the connecting cable 36 which connects the control switch 40 to the cycle computer 30. The cable mounting recess 50 preferably has an end 52 connected to the switch mounting recess 42 and extends on the surface of the control device 44 in the direction of the cycle computer 30. In a preferred embodiment of the invention, when the connecting cable 36 is mounted in the cable mounting recess 50, the connecting cable 36 is flush with the surface 44 of the control device 20. The cable mounting recess 50 preferably retains a portion of the connecting cable 36 securely therein and prevents it from movement.

FIGS. 3 through 7 depict various means of installing the control switch 40 in the switch mounting recess 42 of the control device 20. As shown in FIG. 3, in one embodiment of the invention, the control switch 40 is attached to the switch mounting recess 42 by a double-sided adhesive tape or other adhesive. In the embodiment shown in FIG. 3, an adhesive layer 60 is positioned between the bottom surface 46 of the switch mounting recess and the control switch 40.

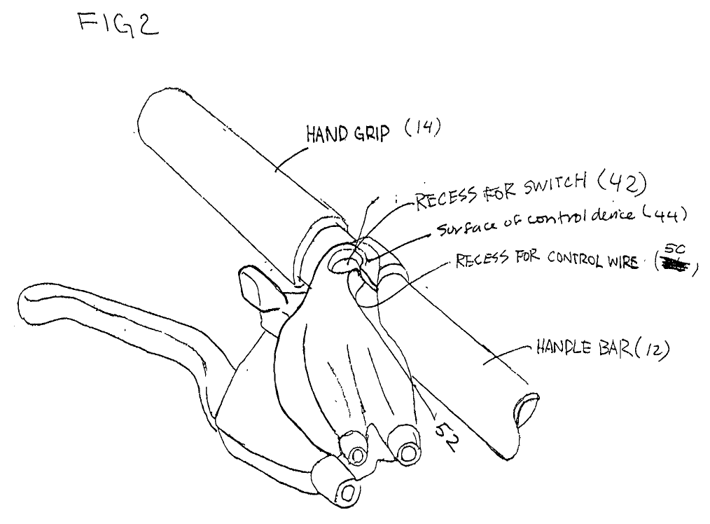

In the embodiment shown in FIG. 4, the control switch 40 includes an outer casing 48 comprised of elastic material. The outer diameter or width of the control switch 40 is preferably larger than the inner diameter or width of the switch mounting recess 42. The control switch 40 is press fit into the switch mounting recess 42 such that the control switch is securely maintained in the switch mounting recess.

In the embodiment shown in FIG. 5, the control switch 40 includes an attachment arm 62 protruding from the bottom thereof. The attachment arm 62 is preferably comprised of an elastic material and press fit into a hole 64 at the bottom 46 of the switch mounting recess 42. In a more preferred embodiment, the outer casing 48 of the control switch 40 and the attachment arm are integrally attached and both comprise of an elastic material.

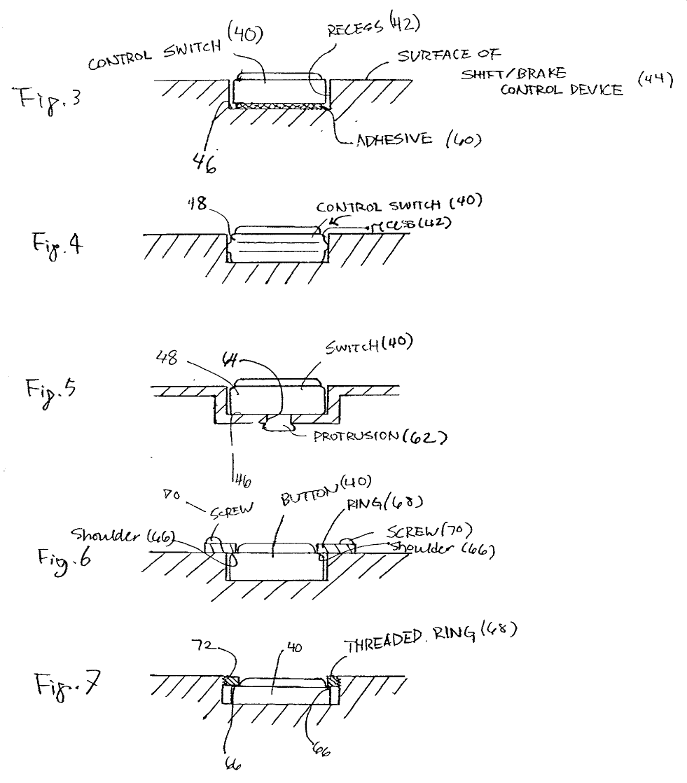

In the embodiment shown in FIG. 6, the outer casing 48 of the control switch 40 includes a shoulder 66. To secure the control switch 40 in the switch mounting recess 42, a retention ring 68 is secured to the top surface 44 of the control device 20 surrounding the control switch 40. The retention ring 68 is dimensioned to restrict the movement of the shoulder 66 such that the shoulder 66 is not able to move outside of the switch mounting recess 42. The retention ring 68 is preferably attached the top surface 44 of the control device 20 by a fastener 70. In the embodiment shown in FIG. 6, fastener 70 is a pair of screws, however, any known fasteners can be used.

In the embodiment shown in FIG. 7, the retention ring 68 is threadingly engaged to the inside diameter 72 of the switch mounting recess 42. The retention ring 68 is positioned proximal the control switch 40 and dimensioned to restrict the motion of the control switch 40. In a preferred embodiment, the retention ring is configured to allow a rider to access and activate the control switch 40 while securely holding the shoulder 66 of the switch in place.

In a preferred embodiment of the invention, the control switch 40 is detachable from the switch mounting recess 42. A detachable switch enables the user to purchase the control device separately from the bicycle computer and switch assembly. Furthermore, if the switch requires repair or maintenance, the switch can be removed without removing the control device entirely.

The embodiments described above are exemplary embodiments of a bicycle control device having a switch mounting recess therein. Those skilled in the art may now make numerous uses of, and departures from, the above-described embodiments without departing from the inventive concepts disclosed herein. Accordingly, the present invention is to be defined solely by the scope of the following claims.

What is claimed is:

1. A bicycle control device comprising a top surface defining a recess therein, wherein the recess forms a container.

2. The bicycle control device of claim 1 wherein the recess is dimensioned to receive a computer control switch.

3. A bicycle shift control device for holding a computer control switch, comprising a top surface defining a recess therein, wherein the recess is dimensioned to receive the computer control switch.

4. A bicycle brake control device for holding a computer control switch, comprising a top surface defining a recess therein, wherein the recess is dimensioned to receive the computer control switch.

5. A control device for holding a computer control switch comprising:
a brake control device;
a shift control device integrated with the brake control device;
a casing encompassing the brake control device and the shift control device, wherein the casing defines a recess therein; and
wherein the recess is dimensioned to receive the computer control switch.

6. A bicycle control device, comprising:
a casing defining a switch mounting recess; and
a control switch mounted in the switch mounting recess.

7. The bicycle control device of claim 6 wherein the control switch is attached in the switch mounting recess by an adhesive.

8. The bicycle control device of claim 7 wherein the switch mounting recess defines a hole therein, the control switch having an attachment arm made of an elastic material, wherein the attachment arm is press fitted into the hole of the switch mounting recess.

9. The bicycle control device of claim 7 further comprising an elastic outer cover wherein the elastic outer cover is press fitted into the switch mounting recess.

10. The bicycle control device of claim 7 further comprising a retention ring configured to restrict the movement of the control switch.

11. The bicycle control device of claim 10 wherein the retention ring is fastened to the casing.

12. The bicycle control device of claim 11 wherein the retention ring is threadingly engaged with the switch mounting recess.

13. A bicycle control assembly for holding a control switch for a computer, comprising:
a control device having a casing defining a switch mounting recess therein;
wherein the switch mounting recess is dimensioned to receive the control switch.

14. The bicycle control assembly of claim 13 wherein the control device comprises a shift control device.

15. The bicycle control assembly of claim 13 wherein the control device comprises a brake control device.

16. The bicycle control assembly of claim 13 wherein the control device comprises a shift control device and a brake control device.

17. The bicycle control assembly of claim 13 wherein the casing defines a cable mounting recess, the cable mounting recess is in communication with the switch mounting recess and extending from the switch mounting recess.

18. A handlebar assembly controllable by the hand of a bicycle rider, comprising:
a handlebar having an end;
a hand grip attached to the end of the handlebar;
a control device attached to the handlebar proximal the hand grip such that the rider's hand can reach the control device while remaining on the hand grip, the control device defining a switch mounting recess therein;
a control switch mounted in the switch mounted recess of the control device;
a cycle computer attached to the handlebar, separate from the control device; and
a connecting cable electrically connecting the control switch to the cycle computer.

19. The handlebar assembly of claim 18, wherein the control device further defines a cable mounting recess in communication with the switch mounting recess, wherein the cable mounting recess extends from the switch mounting recess in the direction of the cycle computer, and wherein a portion of the connecting cable is mounted in the cable mounting recess.

20. A method of installing a control switch, comprising the steps of:
providing a control switch and a control device defining a switch mounting recess therein, wherein the switch mounting recess is dimensioned to receive the control switch; and
securing the control switch in the switch mounting recess.

21. The method of claim 20 wherein the step of securing the control switch comprises adhesively attaching the control switch to the switch mounting recess.

22. The method of claim 20 further comprising the steps of:
providing an attachment arm connected to the control switch, wherein the attachment arm comprises an elastic material;
providing a bottom surface of the switch mounting recess, wherein the bottom surface defines a hole therein; and
press fitting the elastic material into the hole in the bottom surface of the switch mounting recess.

23. The method of claim 20 further comprising the steps of:
providing an elastic outer cover surrounding the control switch; and
press fitting the elastic outer cover into the switch mounting recess.

24. The method of claim 20 further comprising the steps of:
providing a retention ring; and
attaching the retention ring to the control device in a manner that restricts the movement of the control switch.

25. The method of claim 24 wherein the step of attaching the retention ring to the control device includes fastening the retaining ring to a top surface of the control device.

26. The method of claim 24 wherein the step of attaching the retention ring to the control device includes threadingly engaging the ring with the switch mounting recess.
